(19) United States
(12) Patent Application Publication
(10) Pub. No.: US 2019/0180042 A1
(43) Pub. Date: Jun. 13, 2019

(54) IMAGE DISPLAY DEVICE, IMAGE DISPLAY CONTROL DEVICE, AND IMAGE DISPLAY CONTROL METHOD

(71) Applicant: FUJITSU CONNECTED TECHNOLOGIES LIMITED, Kawasaki-shi (JP)

(72) Inventor: Yuichiro Kogami, Kawasaki-shi (JP)

(73) Assignee: FUJITSU CONNECTED TECHNOLOGIES LIMITED, Kawasaki-shi (JP)

(21) Appl. No.: 16/277,880

(22) Filed: Feb. 15, 2019

Related U.S. Application Data
(63) Continuation of application No. PCT/JP2016/074256, filed on Aug. 19, 2016.

(51) Int. Cl. G06F 21/62; G06F 21/31; G06K 9/00

(52) U.S. Cl. CPC G06F 21/6209; G06K 9/00677; G06F 21/31

(57) ABSTRACT

An image display device including a display section configured to display an image includes a storing section, an authenticating section, and a control section. The storing section is configured to store an image and attribute information imparted to the image. The authenticating section is configured to recognize whether a user specified in advance is included in viewers of the image display device when an instruction to display the image on the display section is given. The control section is configured to restrict the displaying the image on the display section based on the attribute information, when a user other than the user specified in advance is included in the viewers of the image display device.

### CROSS-REFERENCE TO RELATED APPLICATION

This application is a continuation application of International Application PCT/JP2016/074256 filed on Aug. 19, 2016 and designated the U.S., the entire contents of which are incorporated herein by reference.

### FIELD

The embodiments discussed herein are related to a method of managing image data.

### BACKGROUND

In recent years, a camera function mounted on a smartphone has been rapidly improved in image quality along with mounting of a photographing element having the same size as a photographing element of a compact digital camera, a high-performance image processing engine, and the like. There are a large number of applications that can perform image processing and image management. Functions including convenience of use of users have been improved. With such improvement of the functions of the smartphone, an increasing number of people use a camera of the smartphone instead of a digital camera in a scene in which the digital camera has been used so far.

Under such circumstances, the smartphone and a tablet terminal have larger liquid crystal screens than the digital camera, and accordingly allow a user to easily show images photographed by the user to other people and two or more persons to view images. Therefore, there is a situation in which, in order to show images saved in a memory to another person, a possessor (hereinafter, owner) of the smartphone temporarily hands the smartphone to an acquaintance or the like (hereinafter, acquaintance) or scrolls image data while viewing images together with the acquaintance.

There has been known a technique for not showing a specific image to other people in a specific period of time (see, for example, Japanese Laid-open Patent Publication No. 2013-158058 (Patent Literature 1)).

There has been known a technique for photographing the face of a viewer, retrieving an image in which the viewer (a subject) is photographed among saved images, and displaying an image having the same attribute as an attribute of the image in which the subject is photographed (see, for example, Japanese Laid-open Patent Publication No. 2015-95082 (Patent Literature 2)).

There has been known a technique for protecting privacy by distinguishing access permitted data, which an owner permits a person other than the owner to access, and access unpermitted data, which the owner does not permit the other person to access (see, for example, Japanese Laid-open Patent Publication No. 2012-19482 (Patent Literature 3)).

When the smartphone is used, images are not deleted from the memory and are accumulated in many cases. Therefore, various kinds of images are highly likely to be saved in the memory. Therefore, when an owner hands the smartphone to the acquaintance or views the images together with the acquaintance, an image that the owner does not want to show to the acquaintance is displayed by mistake due to unexpected operation by the acquaintance or careless scrolling on a screen by the owner.

### SUMMARY

According to an aspect of the embodiments, an image display device including a display section configured to display an image includes a storing section, an authenticating section, and a control section. The storing section is configured to store an image and attribute information imparted to the image. The authenticating section is configured to recognize whether a user specified in advance is included in viewers of the image display device when an instruction to display the image on the display section is given. The control section is configured to restrict the displaying the image on the display section based on the attribute information, when a user other than the user specified in advance is included in the viewers of the image display device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of the configuration of a portable terminal according to an embodiment;

FIG. 2A is a diagram for explaining an example of processing of a control section during image saving, and FIG. 2B is a diagram for explaining an example of processing of a control section during image viewing;

FIG. 3 is a diagram for explaining an example of an activity information DB;

FIG. 4 is a diagram for explaining an example of processing for imparting attributes to image data;

FIG. 5 is an example for explaining an example of an image data management information DB;

FIG. 6 is a diagram for explaining an example of a hardware configuration of a portable terminal;

FIG. 7 is a flowchart for explaining an example of registration and update processing of the activity information DB;

FIG. 8 is a flowchart for explaining an example of processing related to attribute registration during image saving;

FIG. 9 is a flowchart for explaining an example of processing of an object-attribute managing section;

FIG. 10 is a flowchart for explaining an example of processing of a scene-attribute managing section;

FIG. 11 is a flowchart for explaining an example of memorandum image determination processing in the object-attribute managing section and the scene-attribute managing section;

FIG. 12 is a flowchart for explaining an example of processing related to meal image determination processing;

FIG. 13 is a flowchart for explaining an example of processing related to person image determination processing;

FIG. 14 is a flowchart for explaining an example of overnight stay trip determination processing;

FIGS. 15A and 15B are flowcharts for explaining an example of registration processing for an overnight stay trip attribute;

FIG. 16 is a flowchart for explaining an example of determination processing for a day trip image;

FIG. 17 is a flowchart for explaining an example of registration processing for an attribute of a day trip; and

FIG. 18 is a flowchart for explaining an example of processing of the control section during image viewing.

### DESCRIPTION OF EMBODIMENTS

An embodiment is explained in detail below with reference to the drawings.

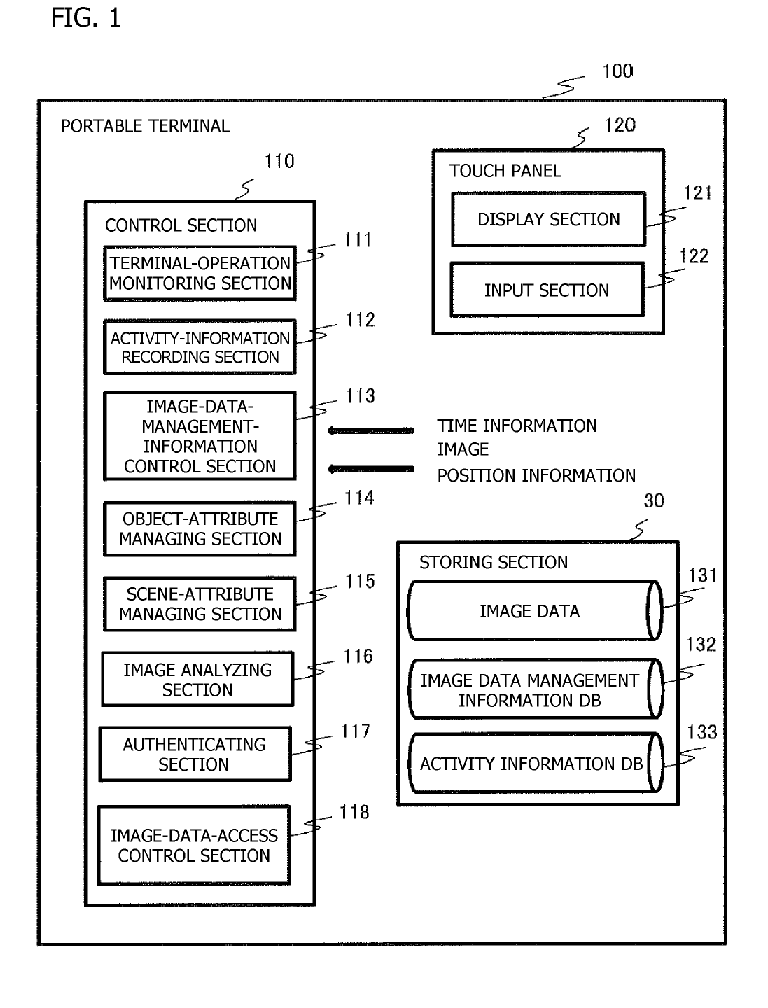

FIG. 1 is a diagram for explaining an example of the configuration of a portable terminal according to an embodiment. A portable terminal 100 includes a control section 110, a touch panel 120, and a storing section 130. The portable terminal 100 is, for example, an image display device.

The touch panel 120 includes a display section 121 and an input section 122. The display section 121 is a liquid crystal display (LCD). The display section 121 displays display objects (images of characters and icons), image data, and the like. The input section 122 detects a touch by a user and detects a time in which the user touches the input section 122 and a coordinate value of a position touched by the user. The input section 122 outputs detected various kinds of information to the control section 110. Note that the input section 122 may be realized by any method such as a resistive film method, an optical method, or a capacitive coupling method used in a touch panel.

The storing section 130 is, for example, a read only memory (ROM), a random access memory (RAM), an electrically erasable programmable read-only memory (EEPROM), a nonvolatile RAM, a flash memory, or a hard disk drive (HDD). The storing section 130 stores application programs and image data 131 processed by the control section 110, owner information used for face recognition of an owner (hereinafter referred to as user as well), and the like. The storing section 130 stores an image data management information database (DB) 132 and an activity information DB 133. The image data management information DB 132 is a database having recorded therein management information of image data saved in the portable terminal 100. The activity information DB 133 is a database having recorded therein actions of the owner of the portable terminal 100.

Further, the portable terminal 100 includes cameras. The cameras are cameras provided on the front surface and the rear surface of the portable terminal 100 and have a photographing function. One camera is used for photographing of the face of the user. A photographed image of the face of the user is used for face recognition, iris recognition, and the like by the control section 110. The other camera is used when the user photographs an object of photographing.

The control section 110 includes a terminal-operation monitoring section 111, an activity-information recording section 112, an image-data-management-information control section 113, an object-attribute managing section 114, a scene-attribute managing section 115, an image analyzing section 116, an authenticating section 117, and an image-data-access control section 118.

The control section 110 can automatically impart, based on activity information representing activities of the owner of the portable terminal 100, attributes corresponding to images photographed using the cameras. Specifically, the terminal-operation monitoring section 111 monitors whether the portable terminal 100 is in use. When the portable terminal 100 is in use, the activity-information recording section 112 acquires information concerning a present position from, for example, a global position system (GPS) and records the activity information of the owner of the portable terminal 100 in the activity information DB 133 in the storing section 130. When some images are photographed by the cameras, the image analyzing section 116 analyzes the photographed images. The object-attribute managing section 114 manages, based on an analysis result of the image analyzing section 116, in association with the images, object attributes representing objects photographed in the images such as people, a meal, and the like. The scene-attribute managing section 115 manages, based on the analysis result of the image analyzing section 116, in association with the images, a scene attribute representing in what kind of a scene the images such as a trip are photographed. The image-data-management-information control section 113 controls, based on management information of the object-attribute managing section 114, the scene-attribute managing section 115, and the like, management information of image data recorded in the image data management information DB 132 stored in the storing section 130.

When the owner temporarily hands an acquaintance the portable terminal 100, in which various image data are saved, in order to show the image data to the acquaintance or views the image data together with the acquaintance, the control section 110 performs control to prevent image data not desired by the owner from being displayed. Specifically, when a new image is displayed on the display section 121 by operation of the owner, the acquaintance, or the like, the authenticating section 117 photographs, with the camera, a person using the portable terminal 100, and recognizes whether the person is the user himself/herself (i.e., the owner) of the portable terminal 100 registered in advance. When the person photographed by the camera is not the owner of the portable terminal 100, the image-data-access control section 118 controls an image that the image-data-access control section 118 causes the display section 121 to display. Alternatively, the authenticating section 117 may recognize whether a person other than the owner of the portable terminal 100 is present in people present in an image obtained by the camera. In this case, if a person other than the owner of the portable terminal 100 is photographed, the image-data-access control section 118 restricts an image displayed on the display section 121. When all the people present in the image obtained by the camera are users registered (permitted) in advance, the control section 110 performs control for displaying the image on the display section 121.

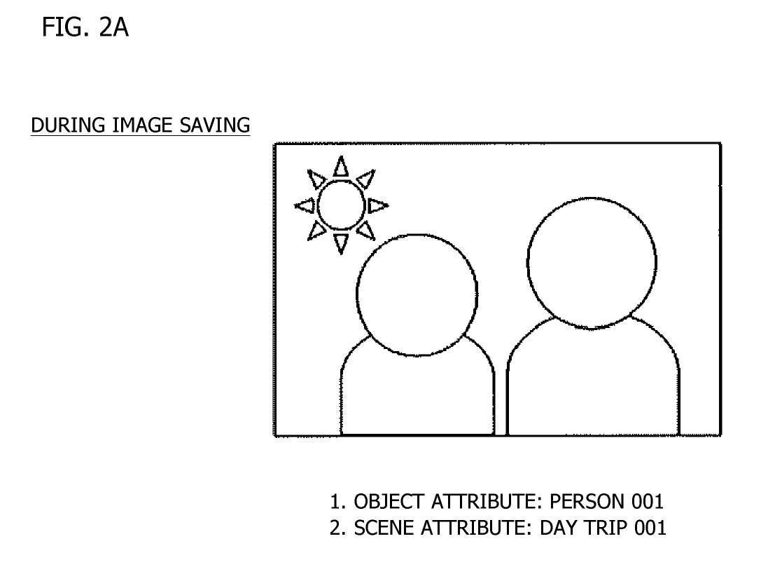

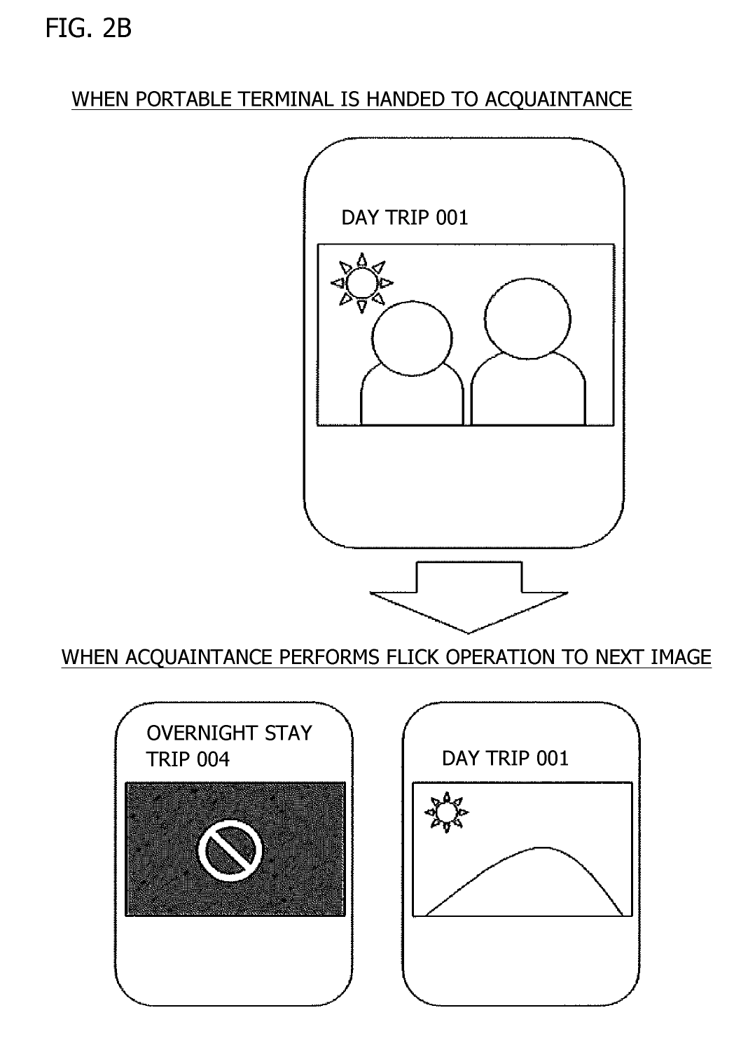

FIG. 2A is a diagram for explaining an example of processing of the control section during image saving. FIG. 2B is a diagram for explaining an example of processing of the control section during image viewing. When images are photographed anew using the cameras and the images are stored in the storing section 130 (during image saving: FIG. 2A), the control section 110 imparts object attributes and scene attributes to the images. The object attributes and the scene attributes are imparted by the object-attribute managing section 114 and the scene-attribute managing section 115 based on an image analysis result. In FIG. 2A, the object-attribute managing section 114 imparts “person 001” to an image photographed anew as an object attribute. The scene-attribute managing section 115 imparts “day trip 001” to the image as a scene attribute. A method of determining an object attribute and a scene attribute is explained in detail below. Saving of the image includes photographing of a photograph, download of a photograph from a browser, and screen capturing in the portable terminal 100.

Subsequently, it is assumed that the portable terminal 100 is handed to an acquaintance of the owner. It is assumed that a large number of images are saved in the portable terminal 100 in addition to the image illustrated in FIG. 2A. Object attributes and scene attributes are imparted to the images saved in the portable terminal 100. When handing the portable terminal 100 to the acquaintance, the owner set a viewing mode in advance in the portable terminal 100. The viewing mode is selected from two kinds of an object mode and a scene mode. When the object mode is selected, the image-data-access control section 118 in the control section 110 determines based on the object attribute whether the image may be displayed. When the scene mode is selected, the image-data-access control section 118 in the control section 110 determines based on the scene attribute whether the image may be displayed. It is assumed that the scene mode is selected by the owner and the scene mode is set in the portable terminal 100.

When the acquaintance performs flick operation (operation for displaying a new image) to the next image in a state where the image imparted with the scene attribute of the day trip 001 is displayed, the authenticating section 117 recognizes, using the camera, whether the user using the portable terminal 100 is the owner himself/herself of the portable terminal 100. When a user who is not the owner himself/herself is projected on the camera, the image-data-access control section 118 determines based on a scene attribute whether the next image (the new image) is displayed. When the scene attribute of the image displayed on the display section 121 and the scene attribute of the next image are the same, the image-data-access control section 118 permits viewing of the next image. That is, if the scene attribute of the next image is the “day trip 001”, the image is displayed on the display section 121 according to the flick operation. On the other hand, when the scene attribute of the image displayed on the display section 121 and the scene attribute of the next image are different, the image-data-access control section 118 does not permit viewing of the next image. For example, if the scene attribute of the next image is “overnight stay trip 004”, the image is not displayed on the display section 121. In this way, when the user (the acquaintance) who is not the owner himself/herself is projected on the camera, the image-data-access control section 118 can restricts an image having an attribute different from the attribute of the currently shown image from being displayed to the acquaintance.

<Collection of Activity Information>

The control section 110 of the portable terminal 100 automatically imparts an object attribute and a scene attribute to image data. For that purpose, the control section 110 collects activity information of the owner of the portable terminal 100 and records the activity information in the activity information DB 133.

For example, when the position of the portable terminal 100 does not change and the portable terminal 100 is not operated for a period longer than a predetermined time (e.g., four hours), the activity-information recording section 112 determines that the owner of the portable terminal 100 is “sleeping”. After determining that the owner of the portable terminal 100 is “sleeping”, when a change of the position of the portable terminal 100 or operation on the portable terminal 100 is detected, the activity-information recording section 112 determines that the owner of the portable terminal 100 starts an activity.

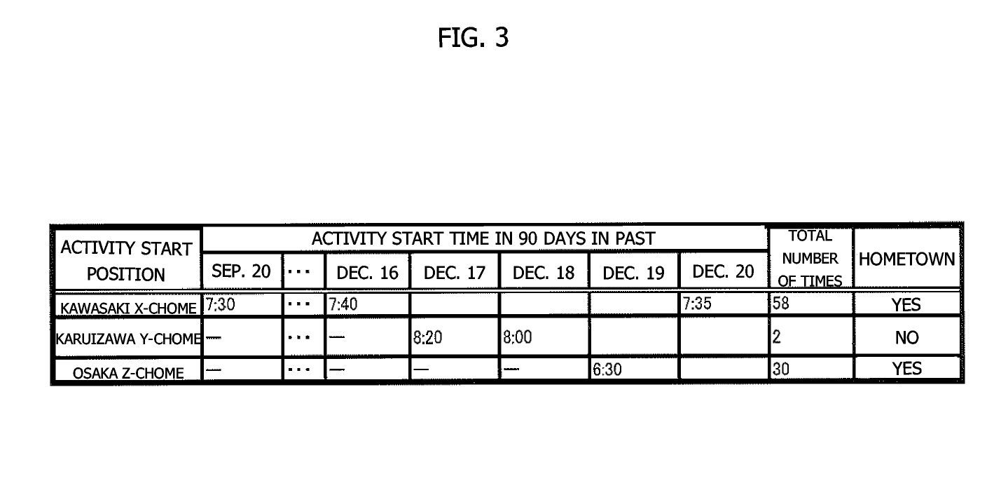

FIG. 3 is a diagram for explaining an example of an activity information DB. The activity-information recording section 112 collects, at an activity start time of one day, time and a place of the activity start based on position information acquired from the GPS and records the time and the place in the activity information DB 133. The activity-information recording section 112 specifies a base (a hometown) of the activity of the owner by accumulating the record. As the activity start of one day, the activity-information recording section 112 detects the activity start of the owner with an acceleration sensor and the like included in the portable terminal 100.

The activity information DB 133 includes items of an activity start position, an activity start time (e.g., in 90 days in the past), a total number of times, and a hometown. The activity start position is information concerning a place at the activity start time of one day collected from the GPS. In a model case illustrated in FIG. 3, for example, a home of the owner is in Kawasaki X-chome, the owner stayed two nights in Karuizawa Y-chome on a trip, moved to and stayed in Osaka Z-chome, which is a second life base, and thereafter returned the home in Kawasaki X-chome. Therefore, Kawasaki X-chome, Karuizawa Y-chome, Osaka Z-chome, and the like are registered in the activity information DB 133 as activity start positions. The activity start time (in 90 days in the past) illustrated in FIG. 3 is a time at the activity start time of one day. In the activity information DB 133 illustrated in FIG. 3, an activity is started in Kawasaki X-chome at 7:30 on September 20. Similarly, in the activity information DB 133 illustrated in FIG. 3, activities of the owner are started in Kawasaki X-chome at 7:40 on December 16, in Karuizawa Y-chome at 8:20 on December 17 and 8:00 on December 18, in Osaka Z-chome at 6:30 on December 19, and in Kawasaki X-chome at 7:35 on December 20.

The total number of times is the numbers of times the activities of the owner are started in the activity start positions. In the activity information DB 133 illustrated in FIG. 3, the numbers of times in the respective activity start positions in 90 days in the past are 58 times in Kawasaki X-chome, twice in Karuizawa Y-chome, and 30 times in Osaka Z-chome. Therefore, in the activity information DB 133 illustrated in FIG. 3, Kawasaki X-chome and Osaka Z-chome are registered as hometowns.

In this way, the activity-information recording section 112 determines the hometowns of the owner of the portable terminal 100 according to the activity information of the owner. By determining the hometowns, for example, when the portable terminal 100 moves to a place other than the hometowns, the portable terminal 100 can determine that, for example, the owner is currently on a trip.

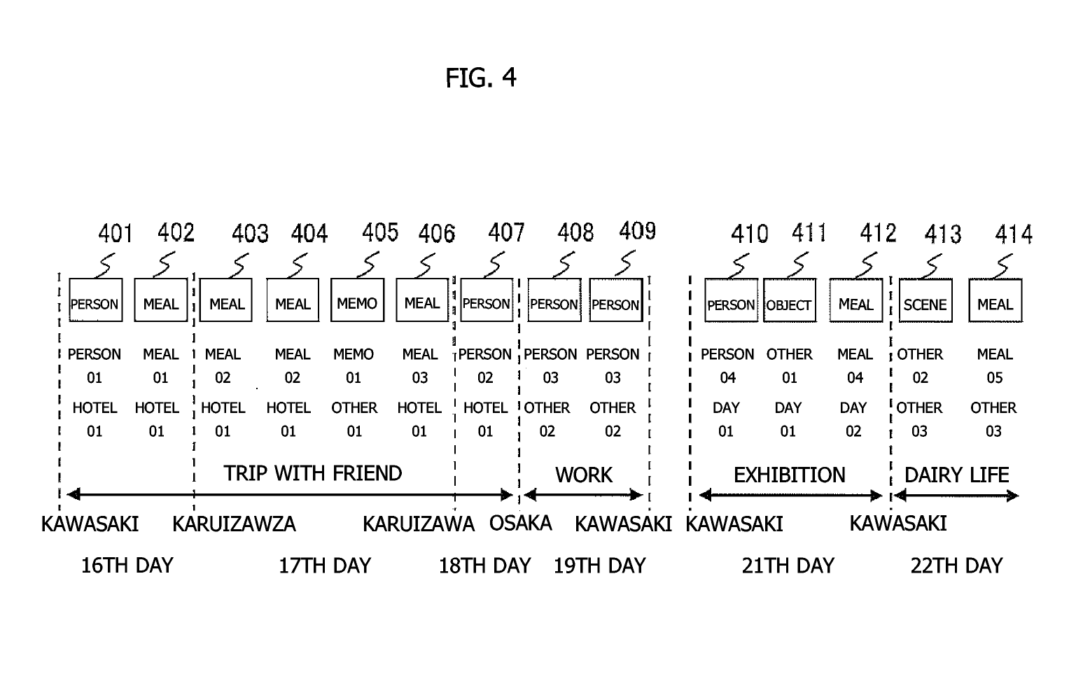

FIG. 4 is a diagram for explaining an example of processing for imparting attributes to image data. In FIG. 4, an example is explained in which the object-attribute managing section 114 and the scene-attribute managing section 115 impart object attributes and scene attributes to images.

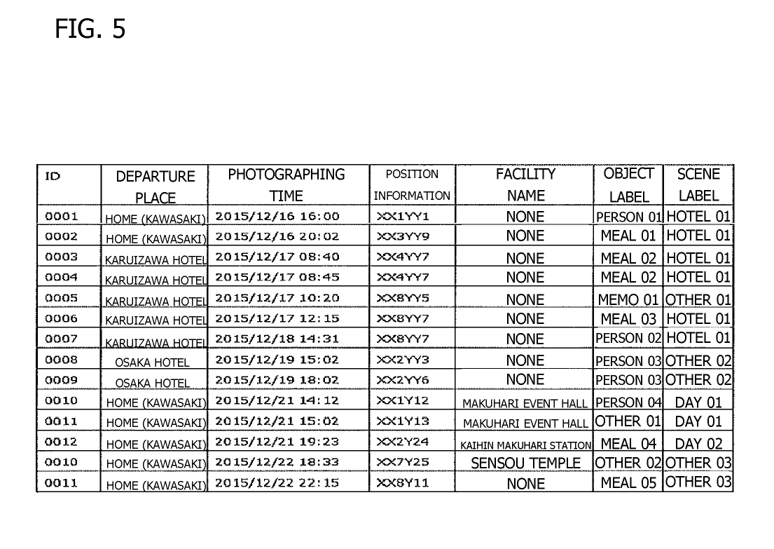

In a case illustrated in FIG. 4 and FIG. 5 referred to below, the owner wakes up in the hometown (Kawasaki) at 7:40 on December 16 and thereafter moves to Karuizawa. The owner photographs a person image 401 at 16:00 of the day during the movement to Karuizawa and photographs a meal image 402 at 20:02. At points in time when the images are photographed, the image analyzing section 116 performs an image analysis. The object-attribute managing section 114 imparts, to the person image 401, “person 01” representing a person attribute imparted when a person is photographed in an image and imparts, to the meal image 402, “meal 01” representing a meal attribute imparted when food is photographed in an image. The numbers included in the attribute information are identification information for distinguishing different objects, different people, and the like having the same attribute. The images and the attribute information associated with the images are stored in the image data management information DB 132. At a point in time when the person image 401 and the meal image 402 are photographed, the scene-attribute managing section 115 once imparts an attribute of “day trip” or “others” to the person image 401 and the meal image 402. Since the owner has already moved from the hometown (Kawasaki) to Karuizawa, the scene-attribute managing section 115 determines that the owner is currently on a trip. Therefore the scene-attribute managing section 115 imparts the attribute of “day trip” to an image. However, at this stage, the scene-attribute managing section 115 is incapable of determining whether the trip is for a plurality of days or is a day trip.

After staying overnight in Karuizawa, the owner photographs a meal image 403 at 8:40 on December 17. Then, at a point in time when the image is photographed, the image analyzing section 116 performs an image analysis. The object-attribute managing section 114 imparts an object attribute of “meal 02” to the meal image 403. Since the portable terminal 100 has not returned to the hometown, the scene-attribute managing section 115 determines that the trip is an overnight stay trip for a plurality of days. The scene-attribute managing section 115 imparts “hotel 1” representing an attribute of an overnight stay trip to the meal image 403. Further, the scene-attribute managing section 115 updates the scene attributes of the person image 401 and the meal image 402 photographed in the previous day to the “hotel 01”.

Thereafter, the owner photographs a meal image 404 in Karuizawa at 8:45 on December 17, a memorandum image 405 at 10:20, and a meal image 406 at 12:15. Then, at points in time when the images are photographed, the image analyzing section 116 performs an image analysis. The object-attribute managing section 114 imparts the object attribute of “meal 02” to the meal image 404 and imparts an object attribute of “meal 03” to the meal image 406. For example, the object-attribute managing section 114 imparts “memo 01” representing a memorandum attribute to the memorandum image 405 in which a memorandum, which is neither a meal nor a person, is photographed. The memorandum image indicates image data downloaded from a browser, a screen-captured image, an image attached to a mail or a social networking service (SNS), or the like and does not include an image photographed by the camera for the purpose of a memorandum. Since the present trip is determined as the overnight stay trip for a plurality of days, the scene-attribute managing section 115 imparts an attribute of “hotel 01” to the meal image 404 and the meal image 406. The scene-attribute managing section 115 imparts, to the memorandum image 405, “other 01”, which is an attribute representing “others” imparted to activities other than the day trip and the overnight stay trip.

The owner photographs a person image 407 in Karuizawa on December 18. Thereafter, the owner moves to Osaka (the hometown). The object-attribute managing section 114 imparts an attribute of “person 02” to the person image 407. The scene-attribute managing section 115 imparts the attribute of “hotel 01” to the person image 407.

On December 19, the owner moves from Osaka (the hometown) to Kawasaki (the hometown). In the movement, the owner photographs a person image 408 and a person image 409. The object-attribute managing section 114 imparts an attribute of “person 03” to the person image 408 and the person image 409. The scene-attribute managing section 115 imparts an attribute of “other 02” to the person image 408 and the person image 409. Since the owner moves between the hometowns, an attribute of the day trip or the overnight stay trip is not imparted and an attribute of others is imparted.

Subsequently, the owner photographs a person image 410 and an object image 411 in a Makuhari event hall where an exhibition is held on December 21. Further, the owner photographs a meal image 412 in the Kaihin Makuhari station when returning home. Then, at points in time when the images are photographed, the image analyzing section 116 performs an image analysis. The object-attribute managing section 114 imparts an attribute of “person 04” to the person image 410. The object-attribute managing section 114 imparts an attribute of “object 01” to the object image 411 in which an object is photographed. The object-attribute managing section 114 imparts an attribute of “meal 04” to the meal image 412. The scene-attribute managing section 115 imparts “day 01” representing a day trip attribute to the person image 410 and the object image 411. The scene-attribute managing section 115 imparts “day 02” representing a day trip attribute to the meal image 412.

On December 22, the owner photographs a scenery image 413 and a meal image 414. Then, at points in time when the images are photographed, the image analyzing section 116 performs an image analysis. The object-attribute managing section 114 imparts an attribute of “other 02” to the scenery image 413 and imparts an attribute of “meal 05” to the meal image 414. The scene-attribute managing section 115 imparts an attribute of “other 03” to the scenery image 413 and the meal image 414.

In this way, the portable terminal 100 analyzes the images and imparts the object attributes and the scene attributes to the images. The kinds of the object attributes and the scene attributes are examples and are not limited.

FIG. 5 is a diagram for explaining an example of the image data management information DB. The image data management information DB 132 includes items of an identifier (ID), a departure place, a photographing time, position information, a facility name, an object attribute, and a scene attribute. The ID is identification information for identifying the respective images of the person image 401 to the meal image 414 illustrated in FIG. 4. The departure place is a place where the activity-information recording section 112 detects the activity start of one day. The photographing time is the times when the respective images of the person image 401 to the meal image 414 are photographed. The position information is information concerning the positions where the respective images of the person image 401 to the meal image 414 are photographed. The position information is acquired by the GPS. The facility name is information indicating based on the position information whether the positions where the images are photographed are some facilities. The object attribute is the object attributes imparted to the images. The scene attribute is the scene attributes imparted to the images.

The portable terminal 100 in the example illustrated in FIGS. 4 and 5 determines based on results of the image analyses that the people, the meals, and the like are photographed in the images and imparts the object attributes to the images.

Since the photographing of the images is performed in the places away from the hometowns for a plurality of days of December 16 to 18, the portable terminal 100 in the example illustrated in FIGS. 4 and 5 determines that the owner is making an overnight stay trip and imparts attributes of the overnight stay trip to the images. When photographing is performed in a place away from the hometowns on December 21, the portable terminal 100 determines that the owner is making a day trip and imparts day trip attributes to the images. In this way, the portable terminal 100 automatically determines scene attributes based on the position information.

When the portable terminal 100 determines based on the object attributes and the scene attributes automatically determined in this way that a user (an acquaintance) who is not the owner himself/herself is projected on the camera, the image-data-access control section 118 can restrict an image having an attribute different from an attribute of a currently shown image from being displayed to the acquaintance.

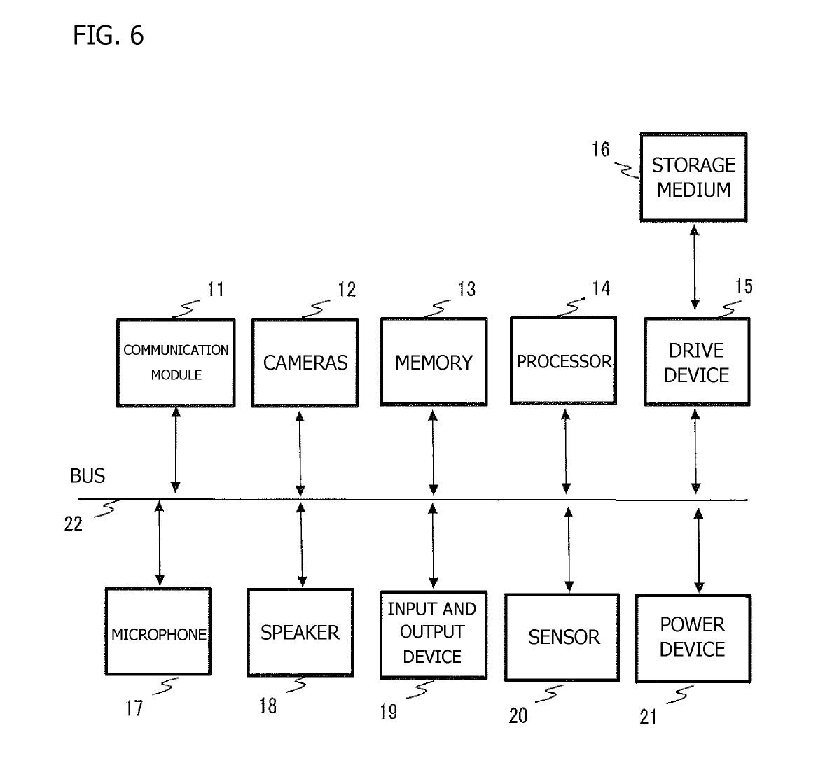

FIG. 6 is a diagram for explaining an example of a hardware configuration of the portable terminal. The portable terminal 100 includes a communication module 11, cameras 12, a memory 13, a processor 14, a drive device 15, a storage medium 16, a microphone 17, a speaker 18, an input and output device 19, a sensor 20, a power device 21, and a bus 22.

The processor 14 is any processing circuit such as a central processing unit. The processor 14 operates as the control section 110 in the portable terminal 100. The processor 14 can execute, for example, computer programs stored in the storage medium 16. The memory 13 operates as the storing section 130 and stores the image data 131, the image data management information DB 132, and the activity information DB 133. Further, the memory 13 also stores, as appropriate, data obtained by the operation of the processor 14 and data used in processing of the processor 14.

The input and output device 19 is realized as an input device such as a button, a keyboard, a mouse, or a touch panel and is further realized as an output device such as a display. The bus 22 connects the communication module 11, the cameras 12, the memory 13, the processor 14, the drive device 15, the storage medium 16, the microphone 17, the speaker 18, the input and output device 19, and the sensor 20 such that data can be exchanged among these devices. The drive device 15 is used to cause the storage medium 16 to operate. The drive device 15 provides the computer programs and data stored in the storage medium 16 to the processor 14 as appropriate.

The communication module 11 is a module that controls communication with other terminals and other devices. Data transmitted and received by the communication module 11 is processed by the processor 14 as appropriate. The cameras 12 are provided on the front surface and the rear surface of the portable terminal 100 and have a function of photographing images. The microphone 17 is a device to which the user using the portable terminal 100 inputs voice. The speaker 18 is a device that outputs the voice received by the portable terminal 100 as sound such that the user can hear the sound. The sensor 20 is a sensor group including an acceleration sensor, an illuminance sensor, and a proximity sensor. The power device 21 supplies electric power for causing the portable terminal 100 to operate.

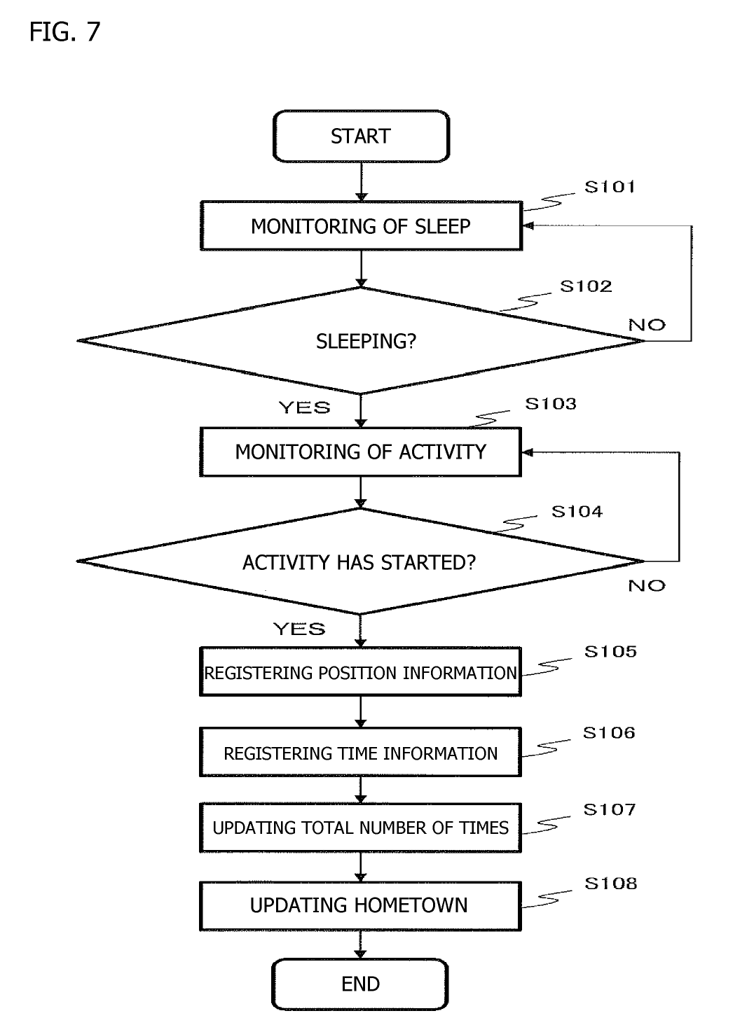

FIG. 7 is a flowchart for explaining an example of registration and update processing of the activity information DB. The terminal-operation monitoring section 111 monitors the operation of the portable terminal 100 (whether the owner carries the portable terminal 100 or operates the portable terminal 100) with the acceleration sensor and the like of the sensor 20 (step S101). The terminal-operation monitoring section 111 determines whether the owner is sleeping according to whether the operation of the portable terminal 100 is not performed for more than a predetermined time (e.g., four hours) (step S102). When the owner is not sleeping (NO in step S102), the terminal-operation monitoring section 111 repeats the processing from step S101.

When the owner is sleeping (YES in step S102), the terminal-operation monitoring section 111 monitors based on the acceleration sensor and the like of the sensor 20 whether the owner wakes up and starts an activity of one day (step S103). The terminal-operation monitoring section 111 determines based on the acceleration sensor and the like of the sensor 20 whether the portable terminal 100 has moved or has been operated and determines whether the owner has started an activity (step S104). When the owner has not started an activity (NO in step S104), the terminal-operation monitoring section 111 repeats the processing from step S103.

When the owner has started an activity (YES in step S104), the activity-information recording section 112 acquires position information from the GPS and registers the position information in the activity information DB 133 (step S105). The activity-information recording section 112 acquires time information and registers the time information in the activity information DB 133 (step S106). The activity-information recording section 112 updates the total number of times of the activity information DB 133 based on the registered position information and the registered time information (step S107). The activity-information recording section 112 update the hometowns of the activity information DB 133 based on the registered position information and the registered time information (step S108).

In this way, the activity-information recording section 112 determines the hometowns of the owner of the portable terminal 100 according to the activity information of the owner. By determining the hometowns, for example, when the portable terminal 100 moves to a place other than the hometowns, the portable terminal 100 can determine whether, for example, the owner is currently on a trip.

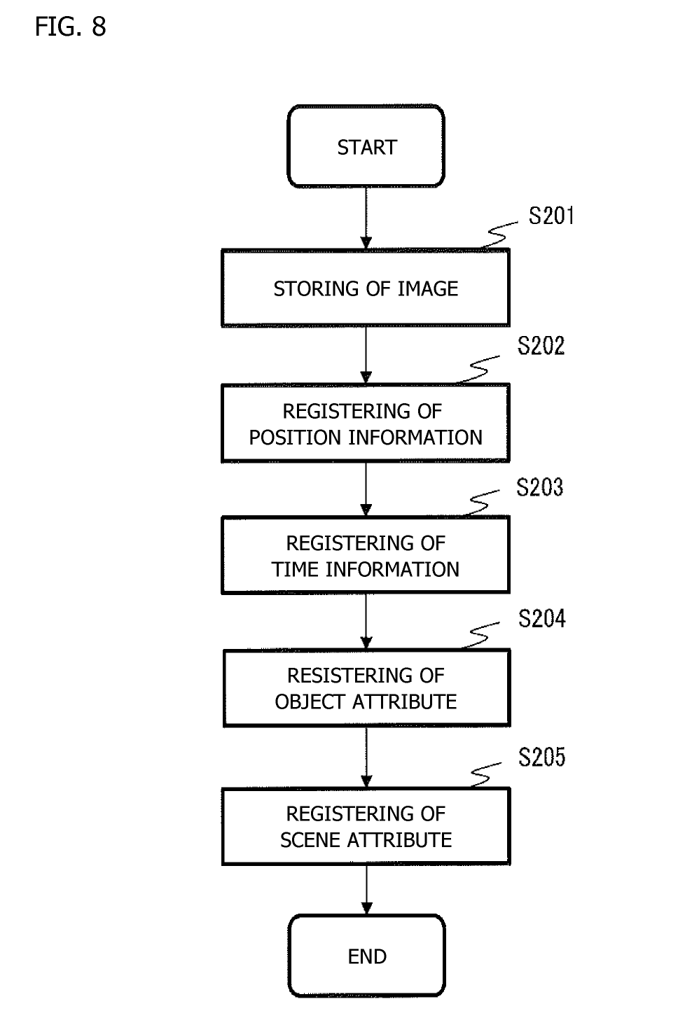

FIG. 8 is a flowchart for explaining an example of processing related to attribute registration during image saving. According to operation of the owner (the user), the image-data-management-information control section 113 stores image data in the storing section 130 (step S201). The image-data-management-information control section 113 acquires a present position from the GPS and registers the present position in the image data management information DB 132 in association with a saved image (step S202). The image-data-management-information control section 113 acquires present time and registers the present time in the image data management information DB 132 in association with the save image (step S203). The object-attribute managing section 114 registers an object attribute in the image data management information DB 132 in association with the saved image (step S204). The scene-attribute managing section 115 registers a scene attribute in the image data management information DB 132 in association with the saved image (step S205).

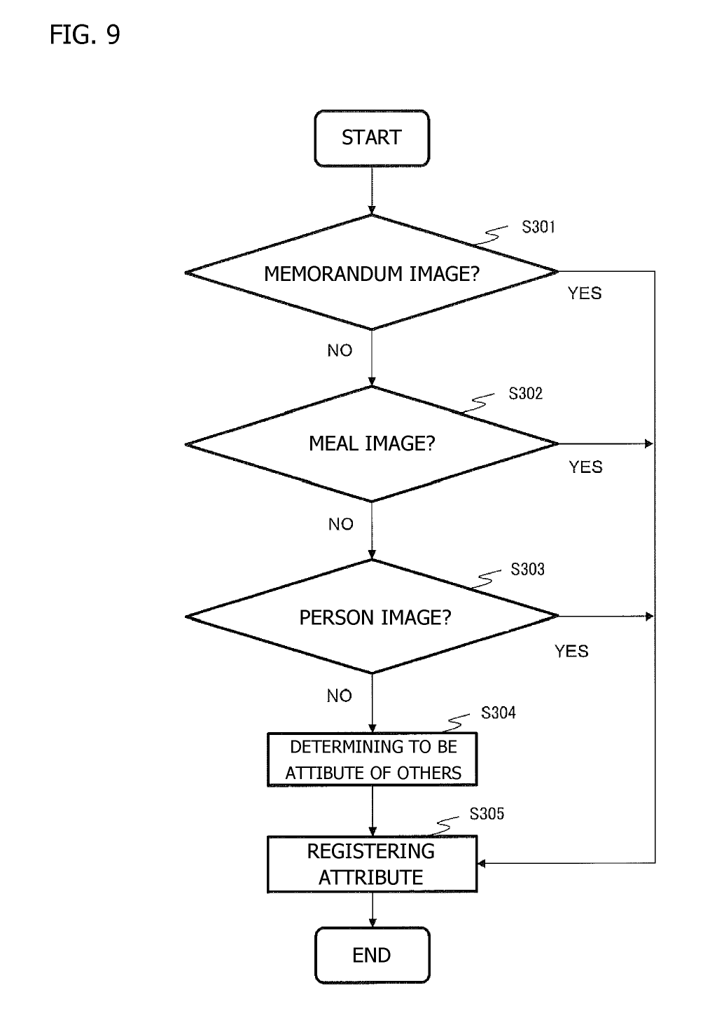

FIG. 9 is a flowchart for explaining an example of processing of the object-attribute managing section. In the flowchart of FIG. 9, an example of the processing of the object-attribute managing section 114 in step S204 in FIG. 8 is explained. The object-attribute managing section 114 determines whether the image is a memorandum image (step S301). When the image is not a memorandum image (NO in step S301), the object-attribute managing section 114 analyzes the image and determines whether the image is a meal image (step S302). When the image is not a meal image (NO in step 302), the object-attribute managing section 114 analyzes the image and determines whether the image is a person image (step S303). When the image is not a person image (NO in step S303), the object-attribute managing section 114 determines that an object attribute of the image is “others” (step S304).

The object-attribute managing section 114 registers the object attribute corresponding to the image in the image data management information DB 132 based on the attribute determination results of the images in steps S301 to 5304 (step S305). When determining that the image is a memorandum image (YES in step S301), the object-attribute managing section 114 saves an object attribute representing “memorandum” in association with the image. When determining that the image is a meal image (YES in step S302), the object-attribute managing section 114 saves an object attribute representing “meal” in association with the image. When determining that the image is a person image (YES in step S303), the object-attribute managing section 114 saves an object attribute representing “person” in association with the image.

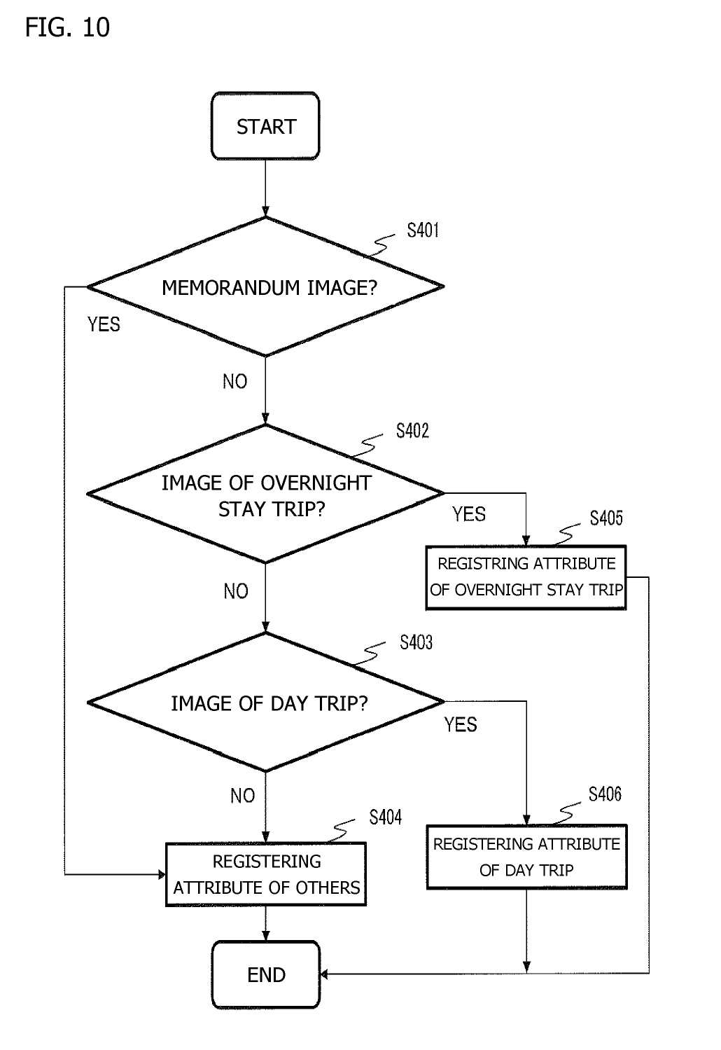

FIG. 10 is a flowchart for explaining an example of processing of the scene-attribute managing section. In the flowchart of FIG. 10, an example of the processing of the scene-attribute managing section 115 in step S205 in FIG. 8 is explained. The scene-attribute managing section 115 determines whether the image is a memorandum image (step S401). When the image is not a memorandum image (NO in step S401), the scene-attribute managing section 115 determines whether the image is an image during an overnight stay trip (step S402). When the image is not an image during an overnight stay trip (NO in step S402), the scene-attribute managing section 115 determines whether the image is an image of a day trip (step S403). When the image is not an image of a day trip (NO in step S404) or when the image is a memorandum image (YES in step S401), the scene-attribute managing section 115 saves a scene attribute of the image as “others” (step S404).

When the image is an image during an overnight stay trip (YES in step S402), the scene-attribute managing section 115 executes registration processing for an overnight stay trip attribute (step S405). When the image is an image of a day trip (YES in step S403), the scene-attribute managing section 115 executes registration processing for a day trip attribute (step S406). When the processing in step S404, step S405, or step S406 ends, the scene-attribute managing section 115 ends the processing for imparting a scene attribute to the image (registering a scene attribute).

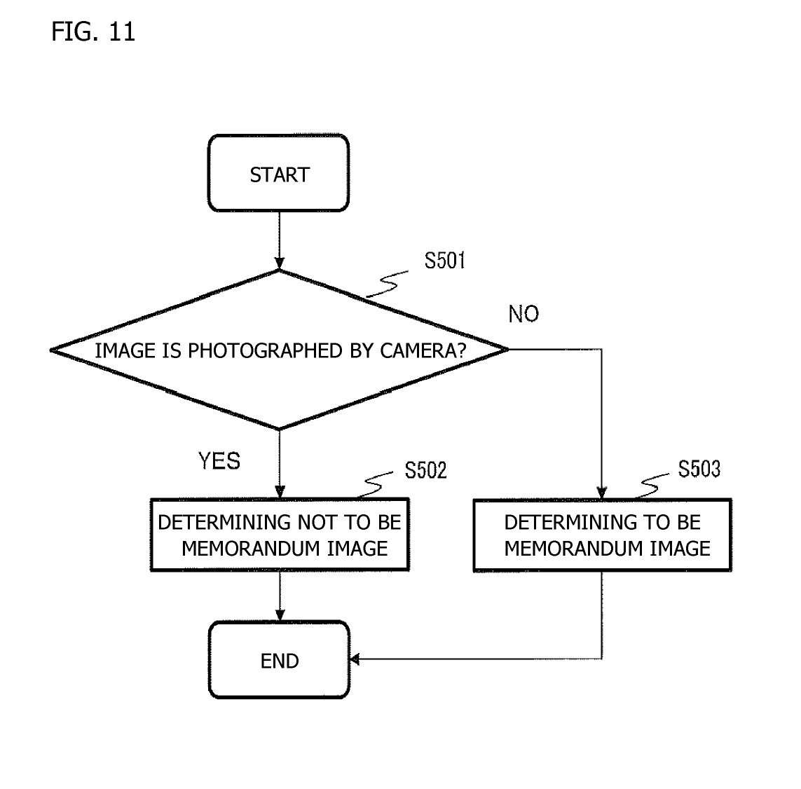

FIG. 11 is a flowchart for explaining an example of memorandum image determination processing in the object-attribute managing section and the scene-attribute managing section. FIG. 11 is a diagram for explaining, in detail, the processing in steps S301 and S401 in the object-attribute managing section 114 and the scene-attribute managing section 115.

The object-attribute managing section 114 (in the case of the processing in step S301) determines whether the image is an image photographed by the camera (step S501). When the image is an image photographed by the camera (YES in step S501), the object-attribute managing section 114 determines that the image is not a memorandum image (step S502). When the image is not an image photographed by the camera (NO in step S501), the object-attribute managing section 114 determines to impart a memorandum attribute to the image (step S503). In the case of the processing in step S401, the scene-attribute managing section 115 executes the processing in steps S501 to S503.

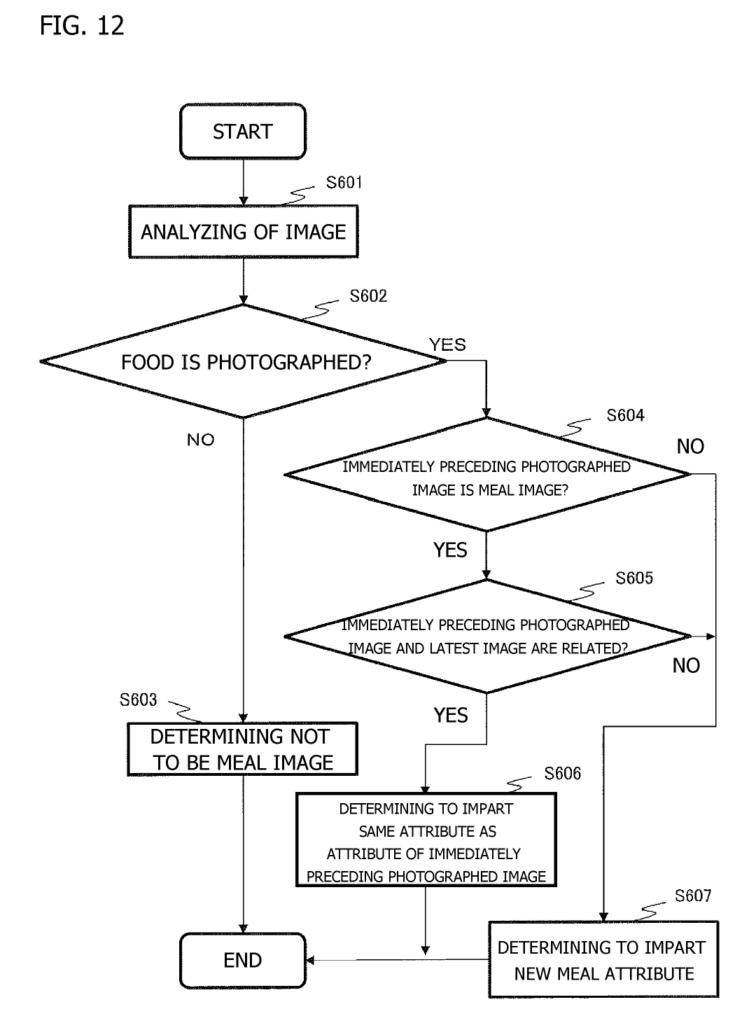

FIG. 12 is a flowchart for explaining an example of processing related to the meal image determination processing. FIG. 12 is a diagram for explaining, in detail, an example of the meal image determination processing in step S302 in FIG. 9. The image analyzing section 116 analyzes the image (step S601). The object-attribute managing section 114 determines whether food is photographed in the image (step S602). When food is not photographed in the image (NO in step S602), the object-attribute managing section 114 determines that the image is not a meal image (step S603). When the processing in step S603 ends, the object-attribute managing section 114 ends the determination processing for determining whether the image is a meal image.

When food is photographed in the image (YES in step S602), the object-attribute managing section 114 determines whether an immediately preceding photographed image is a meal image (step S604). When the immediately preceding photographed image is a meal image (YES in step S604), the object-attribute managing section 114 determines whether the immediately preceding photographed image and the latest image are related in terms of the date and place of the photographing (step S605). When the immediately preceding photographed image and the latest image are related in terms of the date and place of the photographing (YES in step S605), the object-attribute managing section 114 determines to impart the same attribute (meal attribute) as an object attribute of the immediately preceding photographed image to the image (step S606). When the immediately preceding photographed image is not a meal image (NO in step S604) or when the immediately preceding photographed image and the latest image are not related images (NO in step S605), the object-attribute managing section 114 determines to impart a meal attribute allocated with a new number to the image (step S607). When it is determined in step S606 and step S607 to impart the meal attribute to the image, the meal image determination processing ends.

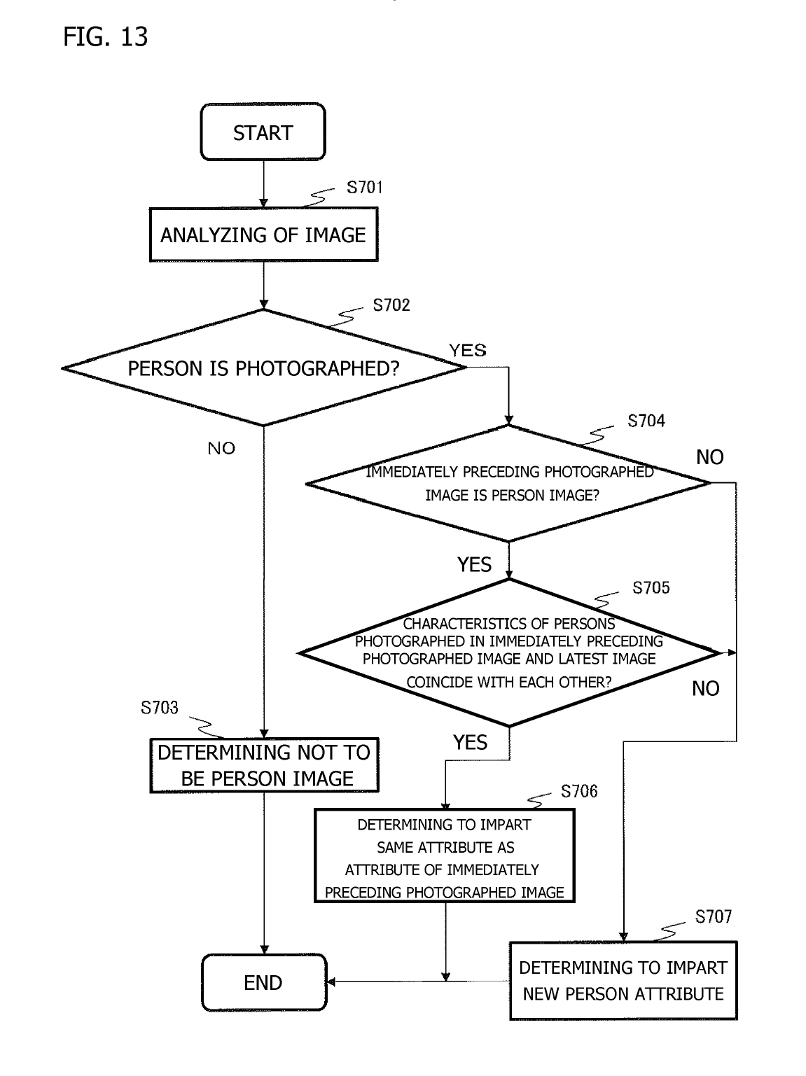

FIG. 13 is a flowchart for explaining an example of processing related to the person image determination processing. FIG. 13 is a diagram for explaining, in detail, an example of the person image determination processing in step S303 in FIG. 9. The image analyzing section 116 analyzes the image (step S701). The object-attribute managing section 114 determines whether a person is photographed in the image (step S702). When a person is not photographed in the image (NO in step S702), the object-attribute managing section 114 determines that the image is not a person image (step S703). When the processing in step S703 ends, the object-attribute managing section 114 ends the determination processing for determining whether the image is a person image.

When a person is photographed in the image (YES in step S702), the object-attribute managing section 114 determines whether an immediately preceding photographed image is a person image (step S704). When the immediately preceding photographed image is a person image (YES in step S704), the object-attribute managing section 114 determines whether characteristics of persons photographed in the immediately preceding photographed image and the latest image coincide with each other (step S705). When the characteristics of the persons photographed in the immediately preceding photographed image and the latest image coincide with each other (YES in step S705), the object-attribute managing section 114 determines to impart the same attribute (person attribute) as an object attribute of the immediately preceding photographed image to the image (step S706). When the immediately preceding photographed image is not a person image (NO in step S704) or when the characteristics of the persons photographed in the immediately preceding photographed image and the latest image do not coincide with each other (NO in step S705), the object-attribute managing section 114 determines to impart a person attribute allocated with a new number to the image (step S707). When it is determined in step S706 and step S707 to impart the person attribute to the image, the person image determination processing ends.

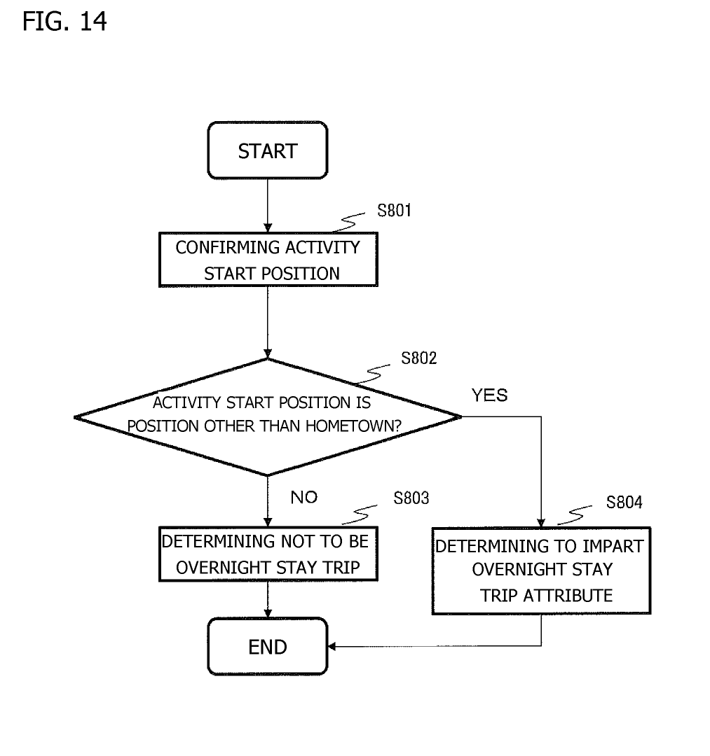

FIG. 14 is a flowchart for explaining an example of the overnight stay trip determination processing. FIG. 14 is a diagram for explaining, in detail, an example of the overnight stay trip determination processing in step S402 in FIG. 10. The scene-attribute managing section 115 confirms an activity start position of the image (step S801). The scene-attribute managing section 115 determines whether the activity start position is a position other than the hometown (step S802). When the activity start position is not a position other than the hometown (NO in step S802), the scene-attribute managing section 115 determines that the trip is not an overnight stay trip (step S803). When the activity start position is a position other than the hometown (YES in step S802), the scene-attribute managing section 115 determines to impart an overnight stay trip attribute to the image (step S804). When the processing in step S803 or step S804 ends, the scene-attribute managing section 115 ends the overnight stay trip determination processing.

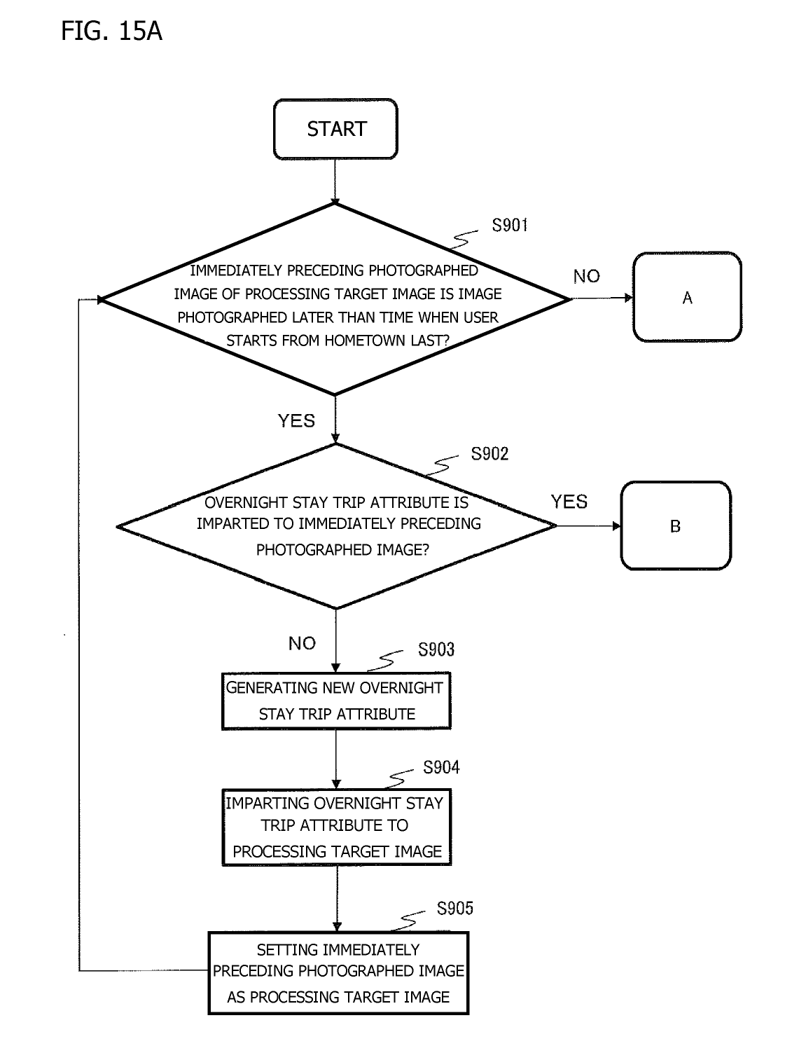

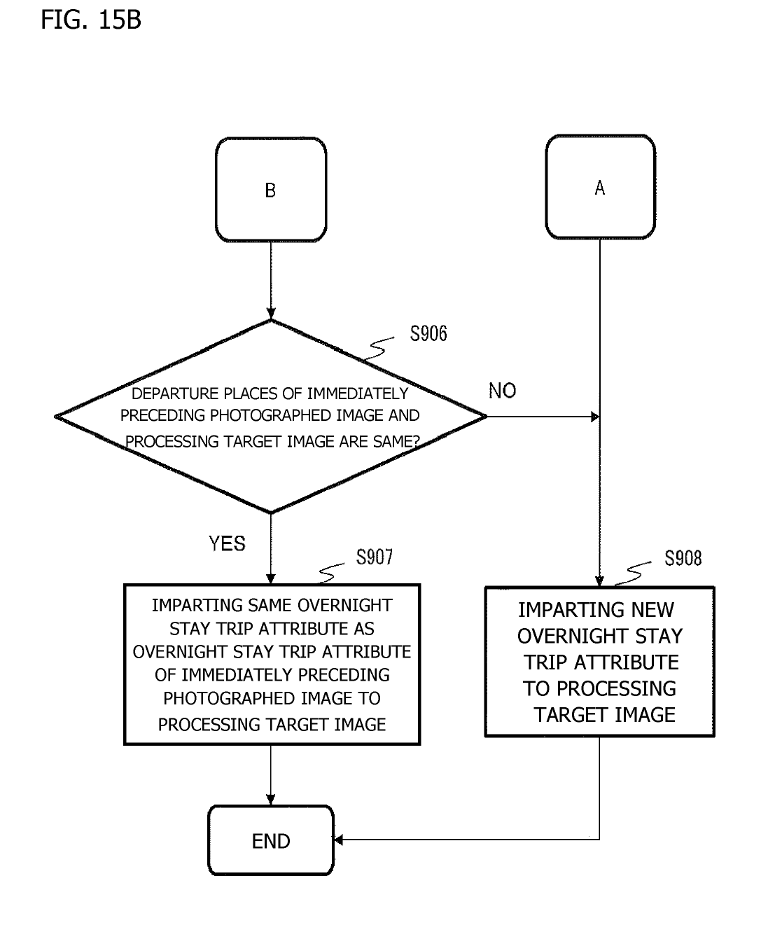

FIGS. 15A and 15B are flowcharts for explaining an example of the registration processing for the overnight stay trip attribute. FIGS. 15A and 15B are diagrams for explaining, in detail, an example of the registration processing for the overnight stay trip attribute in step S405 in FIG. 10. The scene-attribute managing section 115 determines whether an immediately preceding photographed image of the processing target image is an image photographed later than a time when the user starts from the hometown last (step S901). When the immediately preceding photographed image of the processing target image is an image photographed later than the time when the user starts from the hometown last (YES in step S901), the scene-attribute managing section 115 determines whether an attribute of an overnight stay trip is imparted to the immediately preceding photographed image (step S902). When an attribute of an overnight stay trip is not imparted to the immediately preceding photographed image (NO in step S902), the scene-attribute managing section 115 generates a new overnight stay trip attribute (step S903). The scene-attribute managing section 115 imparts the overnight stay trip attribute to the processing target image (step S904). The scene-attribute managing section 115 sets the immediately preceding photographed image as the processing target image (step S905). The scene-attribute managing section 115 shifts the processing target image to the immediately preceding photographed image and repeats the processing from step S901.

When an attribute of an overnight stay trip is imparted to the immediately preceding photographed image (YES in step S902), the scene-attribute managing section 115 determines whether departure places of the immediately preceding photographed image and the processing target image are the same (step S906). When the departure places of the immediately preceding photographed image and the processing target image are the same (YES in step S906), the scene-attribute managing section 115 imparts the same overnight stay trip attribute as an overnight stay trip attribute of the immediately preceding photographed image to the processing target image (step S907). When the immediately preceding photographed image of the processing target image is not an image photographed later than the time when the user starts from the hometown last (NO in step S901) or when the departure places of the immediately preceding photographed image and the processing target image are not the same (NO in step S906), the scene-attribute managing section 115 imparts a new overnight stay trip attribute to the processing target image (step S908). After imparting the overnight stay trip attribute to the processing target image in step S907 or step S908, the scene-attribute managing section 115 ends the registration processing for the overnight stay trip attribute.

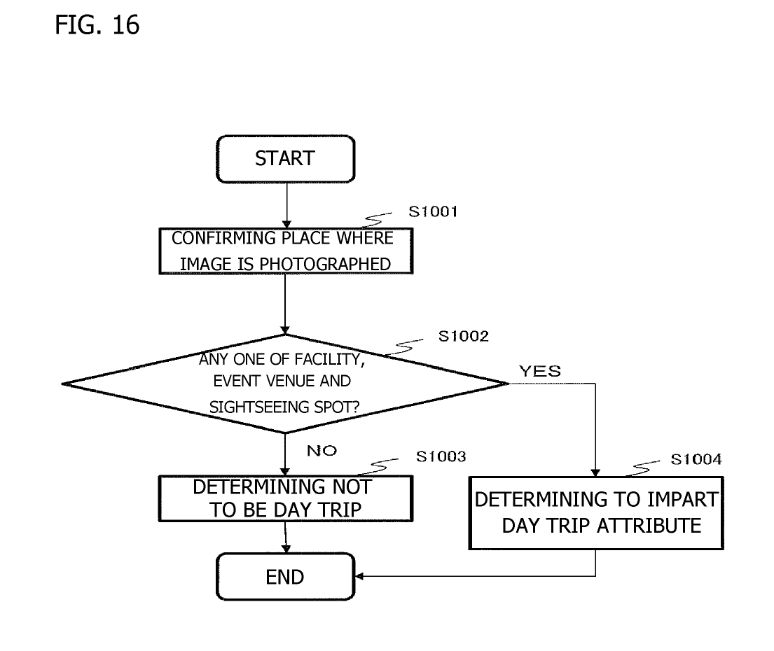

FIG. 16 is a flowchart for explaining an example of the determination processing for a day trip image. FIG. 16 is a diagram for explaining, in detail, an example of the determination processing for a day trip image in step S403 in FIG. 10. The scene-attribute managing section 115 confirms, based on position information acquired from the GPS, a place where the image is photographed (step S1001). The scene-attribute managing section 115 determines whether the place where the image is photographed is any one of a facility, an event venue, and a sightseeing spot (step S1002). When the place where the image is photographed is not a facility, an event venue, or a sightseeing spot (NO in step S1002), the scene-attribute managing section 115 determines that the trip is not a day trip (step S1003). When the place where the image is photographed is a facility, an event venue, or a sightseeing spot (YES in step S1002), the scene-attribute managing section 115 determines to impart a day trip attribute to the image (step S1004). When the processing in step S1003 or step S1004 ends, the scene-attribute managing section 115 ends the day trip determination processing.

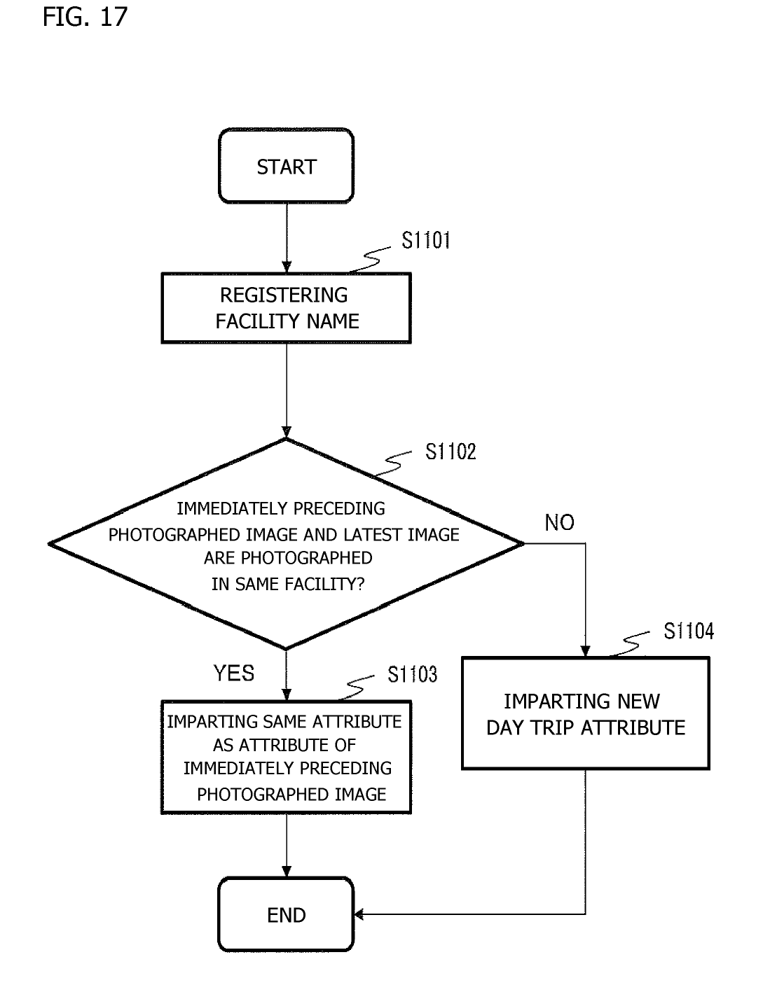

FIG. 17 is a flowchart for explaining an example of the registration processing for an attribute of a day trip. FIG. 17 is a diagram for explaining, in detail, an example of registration processing for a day trip attribute in step S406 in FIG. 10. The scene-attribute managing section 115 registers a name of a facility where the image is photographed in the image data management DB 132 based on position information acquired from the GPS (step S1101). The scene-attribute managing section 115 determines whether an immediately preceding photographed image and the latest image are images in the same facility (step S1102). When the immediately preceding photographed image and the latest image are images in the same facility (YES in step S1102), the scene-attribute managing section 115 imparts the same day trip attribute as a day trip attribute of the immediately preceding photographed image to the latest image (step S1103). When the immediately preceding photographed image and the latest image are not images in the same facility (NO in step S1102), the scene-attribute managing section 115 imparts a new day trip attribute to the latest image (step S1104). When the processing in step S1103 or step S1104 ends, the scene-attribute managing section 115 ends the registration processing for a day trip attribute.

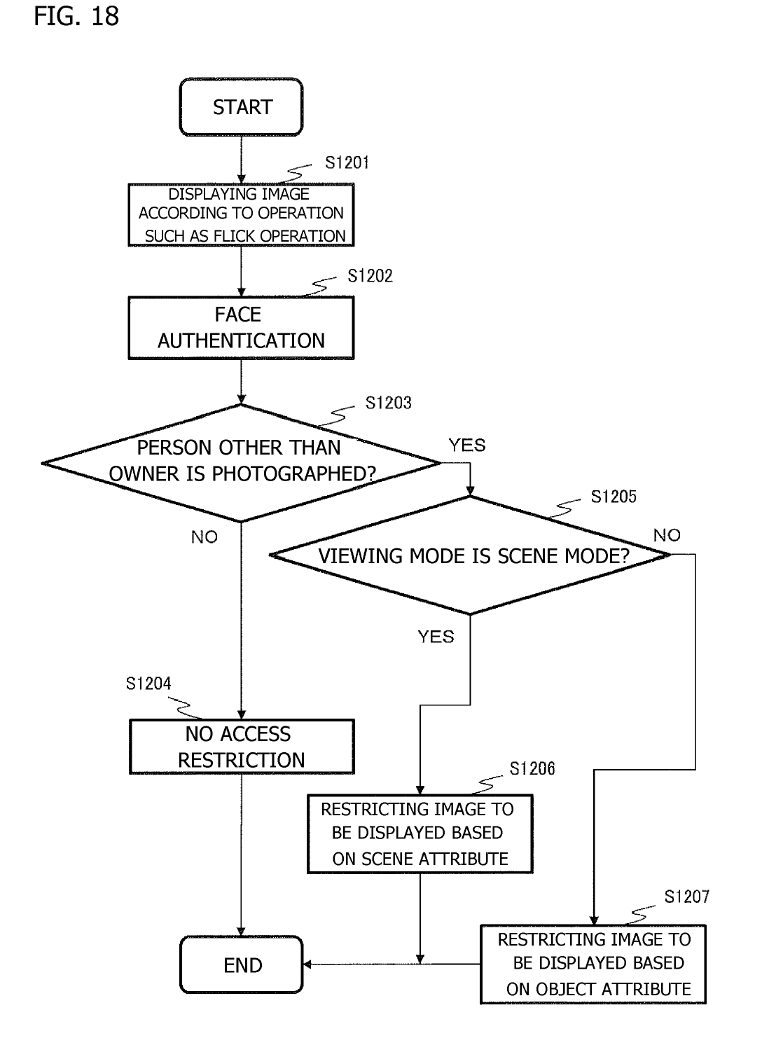

FIG. 18 is a flowchart for explaining an example of processing of the control section during image viewing. The display section 121 displays an image according to operation for displaying an image input to the input section 122 (step S1201). The authenticating section 117 authenticates a face of a viewer of the portable terminal 100 with the camera (step S1202). The authenticating section 117 determines whether a person other than the owner (the user specified in advance) is photographed in the image (step S1203). When a person other than the owner is not photographed in the image (NO in step S1203), the image-data-access control section 118 does not apply access restriction to an image to be displayed (step S1204).

When a person other than the owner is photographed in the image (YES in step S1203), the image-data-access control section 118 determines whether the viewing mode is the scene mode (step S1205). When the viewing mode is the scene mode (YES in step S1205), the image-data-access control section 118 restricts an image to be displayed based on a scene attribute of the image (step S1206). When the viewing mode is the object mode (NO in step S1205), the image-data-access control section 118 restricts an image to be displayed based on an object attribute of the image (step S1207).

When the owner temporarily hands the portable terminal 100, in which various image data are saved, to an acquaintance in order to show the image data to the acquaintance or view the image data together with the acquaintance, the control section 110 performs control to prevent image data not desired by the owner from being displayed. Specifically, when a new image is displayed on the display section 121 by operation of the owner, the acquaintance, or the like, the authenticating section 117 photographs, with the camera, a person using the portable terminal 100, and recognizes whether the person is the user himself/herself (i.e., the owner) of the portable terminal 100 registered in advance. When the person photographed by the camera is not the owner of the portable terminal 100, the image-data-access control section 118 controls an image that the image-data-access control section 118 causes the display section 121 to display. Alternatively, the authenticating section 117 may recognize whether a person other than the owner of the portable terminal 100 is present in people present in an image obtained by the camera. In this case, if a person other than the owner of the portable terminal 100 is photographed in the image, the image-data-access control section 118 restricts an image to be displayed on the display section 121.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image display device including a display section configured to display an image, the image display device comprising:
a managing section configured to impart attribute information to each of a first image and a second image;
a storing section configured to store the first image, the attribute information imparted to the first image, the second image, and the attribute information imparted to the second image;
an authenticating section configured to recognize whether a user specified in advance is included in viewers of the image display device when an instruction to display the second image on the display section is given in a state where the first image is displayed on the display section; and
a control section configured to, when a user other than the user specified in advance is included in the viewers of the image display device, compare the attribute information of the second image with the attribute information of the first image, and display the second image on the display section when the attribute information of the first image and the attribute information of the second image coincide with each other and restrict the displaying the second image on the display section when the attribute information of the first image and the attribute information of the second image do not coincide with each other.

2. The image display device according to claim 1, further comprising:
a camera configured to photographs the viewers of the image display device, wherein
when the instruction to display the second image on the display section is given, the authenticating section analyzes an image photographed by the camera to thereby recognize whether a user other than the user specified in advance is included in the viewers of the image display device.

3. The image display device according to claim 1, wherein the attribute information includes an object attribute obtained as a result of analyzing the image.

4. The image display device according to claim 1, wherein the attribute information includes a scene attribute obtained based on position information of the image display device.

5. The image display device according to claim 1, wherein the control section performs control to display the second image on the display section when all the viewers of the image display device are users specified in advance.

6. An image display control device configured to control an image to be displayed, the image display control device comprising:
a managing section configured to impart attribute information to each of a first image and a second image;
a storing section configured to store the first image, the attribute information imparted to the first image, the second image, and the attribute information imparted to the second image;
an authenticating section configured to recognize whether a user specified in advance is included in viewers of an image display device when an instruction to display the second image on a display section that displays the image is given in a state where the first image is displayed on the display section; and
a control section configured to, when a user other than the user specified in advance is included in the viewers of the image display device, compare the attribute information of the second image with the attribute information of the first image, and display the second image on the display section when the attribute information of the first image and the attribute information of the second image coincide with each other and restrict the displaying the second image on the display section when the attribute information of the first image and the attribute information of the second image do not coincide with each other.

7. A non-transitory computer-readable recording medium having stored therein a program for causing a computer to execute an image display control process that controls an image to be displayed on a screen, the image display control process comprising:
imparting attribute information to each of a first image and a second image;
storing the first image, the attribute information imparted to the first image, the second image, and the attribute information imparted to the second image;
when an instruction to display the second image on the screen is given in a state where the first image is displayed on the screen, authenticating whether a user specified in advance is included in viewers of an image display device;
when a user other than the user specified in advance is included in the viewers of the image display device, comparing the attribute information of the second image with the attribute information of the first image; and
displaying the second image on the screen when the attribute information of the first image and the attribute information of the second image coincide with each other and restricting the displaying the second image on the screen when the attribute information of the first image and the attribute information of the second image do not coincide with each other.

8. An image display control method of controlling an image to be displayed on a screen, the image display control method comprising:
imparting, by a processor, attribute information to each of a first image and a second image;
storing, by the processor, the first image, the attribute information imparted to the first image, the second image, and the attribute information imparted to the second image;
when an instruction to display the second image on the screen is given in a state where the first image is displayed on the screen, recognizing, by the processor, whether a user specified in advance is included in viewers of an image display device;
when a user other than the user specified in advance is included in the viewers of the image display device, comparing, by the processor, the attribute information of the second image with the attribute information of the first image; and
displaying, by the processor, the second image on the screen when the attribute information of the first image and the attribute information of the second image coincide with each other and restricting, by the processor, the displaying the second image on the screen when the attribute information of the first image and the attribute information of the second image do not coincide with each other.
